(19) United States
(12) Patent Application Publication
(10) Pub. No.: US 2026/0266259 A1
(43) Pub. Date: Sep. 10, 2026

(54) VERTICAL AXIS WIND TURBINE

(71) Applicant: PANEMONDIAL LTD, Sudbury (GB)

(72) Inventor: Lin WANG, Nottingham (GB)

(21) Appl. No.: 19/489,275

(22) PCT Filed: May 28, 2024
(86) PCT No.: PCT/GB2024/051363

§ 371 Date: Dec. 2, 2025

(30) Foreign Application Priority Data
Jun. 2, 2023 (GB) 2308291.0

(51) Int. Cl. F03D 3/04; F03D 3/00

(52) U.S. Cl. CPC F03D 3/0409; F03D 3/005; F03D 3/0427

(57) ABSTRACT

The present invention provides a shroud for a vertical axis wind turbine. The shroud is configured in use to externally surround a rotor of a vertical axis wind turbine. The shroud comprises: upper and lower axially spaced apart supports, configured in use to be respectively positioned above and below the rotor, and each support has a radially outer periphery defining a polygonal shape with a plurality of circumferentially distributed corners. The shroud comprises a plurality of circumferentially distributed stators each extend longitudinal between a corner of the upper support and a corner of the lower support such that adjacent pairs of stators and the interposed sections of the outer periphery of the upper and lower support define a plurality of quadrilateral frames configured in use to circumferentially surround the rotor.

### FIELD OF INVENTION

The present invention relates to a vertical axis wind turbine. Particularly, but not exclusively, the invention may relate to a modular shrouded vertical axis wind turbine.

### BACKGROUND

Wind energy is an important source of renewable energy. In recent years offshore wind energy has emerged as a promising source of renewable energy due to having several advantages over onshore wind energy. Offshore wind turbines are exposed to stronger and more consistent winds, which results in higher energy production potential. Additionally, they have reduced visual and noise pollution and minimal land-use conflicts, making them an attractive option for clean energy production.

Wind turbines can be designed with a rotor blade which rotates about either a vertical or horizontal rotational axis and are accordingly designated as either a horizontal axis wind turbine (which may be referred to as a HAWT) or as a vertical axis wind turbine (which may be referred to as a VAWT). Vertical axis wind turbines have several advantages over horizontal axis wind turbines. Vertical axis wind turbines are capable of producing power from wind blowing in any direction, whereas horizontal axis wind turbines require a wind direction perpendicular to the rotor blades' plane to generate power. As such, vertical axis wind turbines do not require a yaw mechanism to turn the rotor towards the wind, making them less complex and less expensive to maintain.

The adoption of vertical axis wind turbines has, however, been limited as current designs generally have lower efficiency than comparable horizontal axis wind turbines. This is due to vertical axis designs providing lower aerodynamic efficiency and resulting low power generation. The reduced efficiency of vertical axis wind turbines results in providing lower energy production and reduced economic viability and has, for example, limited their application to large-scale offshore wind farms.

Some advanced vertical axis wind turbine designs have been proposed to seek to address some of the efficiency disadvantages. For example, UK Patent Application GB2468881 discloses a vertical axis wind turbine which uses swept, inclined aerofoils and which, optionally, includes an augmenter cage around the rotor to segment the flow of air onto the rotor. U.S. Pat. No. 4,857,753 discloses a vertical axis wind turbine having a circular turbine and a stator surrounding and coaxial with the turbine. The stator comprises an upper annular body adjacent the upper end of the turbine and a lower annular body adjacent the lower end of the turbine.

Whilst these proposals may increase the efficiency of a vertical axis wind turbine there remains a desire to provide a high efficiency vertical axis wind turbine with a simple, reliable, and robust construction. Such a turbine may, for example, be suitable for use in offshore turbine applications where ease of maintenance and repair may be an essential factor in the overall cost effectiveness of the turbine. Accordingly, embodiments of the invention seek to provide an alternate vertical axis wind turbine which may address at least some of these advantages.

### SUMMARY OF INVENTION

According to a first aspect of the invention, there is provided a shroud for a vertical axis wind turbine. The shroud is configured in use to externally surround a rotor of a vertical axis wind turbine. The shroud comprises upper and lower axially spaced apart supports, respectively positioned above and below the rotor. Each support has a radially outer periphery defining a polygonal shape with a plurality of circumferentially distributed corners. A plurality of circumferentially distributed stators each extend longitudinal between a corner of the upper support and a corner of the lower support. As such, adjacent pairs of stators and the interposed sections of the outer periphery of the upper and lower support define a plurality of quadrilateral frames. The frames are configured in use to circumferentially surround the rotor.

According to a second aspect of the invention, there is provided a vertical axis wind turbine. The turbine comprises a central hub defining the axis of the turbine the axis being generally vertically aligned in use. The turbine also comprises a rotor comprising a plurality of blades circumferentially distributed about the axis. The blades are supported by at least one radially extending support, rotatably mounting the blade relative to the central hub. A shroud externally surrounds the rotor. The shroud comprises upper and lower axially spaced apart supports, respectively positioned above and below the rotor. Each support has a radially outer periphery defining a polygonal shape with a plurality of circumferentially distributed corners. A plurality of circumferentially distributed stators each extend longitudinal between a corner of the upper support and a corner of the lower support. As such, adjacent pairs of stators and the interposed sections of the outer periphery of the upper and lower support define a plurality of quadrilateral frames. The frames circumferentially surround the rotor.

The central hub may comprise a shaft or axle. The central hub may further comprise a fixed structure. The shaft or axle may be rotatable relative to the fixed structure. The central hub may include support bearings.

The plurality of rotor blades may comprise at least two rotor blades, in particular the rotor may have three rotor blades. Each blade may extend longitudinally in the axial direction of the wind turbine. In some embodiments the blades may be canted or curved in the longitudinal direction. In some embodiments the longitudinal axis of each rotor blades may be parallel to the turbine axis (i.e. vertically aligned in use).

The at least one radially extending support rotatably mounting the blade relative to the central hub may comprise a pair of axially spaced apart support members. A first radially extending support member may be coupled to an upper portion of the blade. A second radially extending support member may be coupled to a lower portion of the blade. A blade support assembly may comprise at least one radially extending support for each blade of the plurality of blades. The blade support assembly may for example comprise a plurality of radially extending spokes each connecting to one of the plurality of blades.

The upper and lower support may each comprise a radial outer periphery consisting of a plurality of tangentially extending members with adjacent members interconnected at the circumferentially distributed corners. The applicant has recognized that the use of a polygonal shaped upper and lower supports for the shroud is advantageous over the use of a circular arrangement. For example, the straight sided sections provided by the polygonal form provide a greater cross section which can be used to provide an increased mass flow through the turbine. The straight sided shape is also beneficial in simplifying the manufacture of the shroud. Accordingly, embodiments may benefit from reduced material and manufacturing costs whilst also advantageous increasing energy production.

The radially outwardly facing surfaces of the interposed sections of the upper and lower supports may be radially inwardly converging. As such, the outwardly facing surfaces of the upper frame may be downwardly angled and the outwardly facing surface of the lower frame may be upwardly angled. The converging arrangement of the faces may result in each quadrilateral frame effectively defining a converging duct. Thus, it can be appreciated that each face formed by the polygonal shape of the shroud can provide an increased surface area to direct wind onto the rotor of the turbine. The converging surfaces of the outwardly facing surface are angled at 30 degrees to the perpendicular to the axis of the turbine. It will be appreciated that the perpendicular to the axis of the turbine is generally considered to be horizontally aligned.

The upper and lower supports may define a regular polygonal shape. The polygonal shape may for example have between 6 and 12 sides. In particular, the polygonal shape may be an octagon. An octagonal shroud shape has been found to provide a particularly effective shape for maximising the surface area and effect of the converging ducts whilst also providing a structure which is structurally stable, and which is simple to manufacture, and which requires less material to achieve the same cross-sectional area as an equivalent circular configuration.

The corresponding corners (which may be understood to be the corners which connect to opposing ends of a common stator) of the upper and lower supports may be circumferentially aligned. As such, each stator extends parallel to the axis of the turbine.

The shroud may comprise a truss structure. The upper and lower supports may each comprise a generally planar framework. The upper and lower supports may be axially separated by the plurality of stators. In embodiments, the shroud defines a cage fully enclosing the rotor. The shroud may be a support structure. For example, the shroud may be configured to be positioned on a seabed foundation, on for example a wind turbine site.

The upper and lower supports may each comprise a plurality of radial spokes connecting the framework to the central hub. A radial spoke extends to each corner of the framework. Thus, the truss structure formed by the shroud may comprise connections at the corner of the polygonal between the stators, radial spokes, and the adjacent sections of the outer periphery of the upper or lower supports.

The plurality of stators may each be formed from rectangular cross-section beams. The rectangular cross section beams may be transversely radially aligned (and longitudinally parallel to the axis of the turbine). The use of rectangular cross-sections for the stator blades in embodiments has been found to provide several advantages over traditional aerofoil cross-sectional stator blades. For example, rectangular cross-sections are easier and less expensive to manufacture than aerofoil cross-sections. Aerofoil cross-sections are often complex in shape and require precision manufacturing techniques, while rectangular cross-sections can be produced using simpler manufacturing methods, reducing production costs. Additionally, rectangular cross-sections have a larger surface area than aerofoil cross-sections allowing for better control of the airflow and improved energy transfer to the rotor blades. Rectangular cross-sections also provide more structural stability and rigidity to the stator blades, which may enhance the overall performance and durability of the shroud and/or reduce the need for additional supporting structure.

In embodiments the vertical axis wind turbine may be provided in a modular form. For example, in embodiments a central hub, a rotor and a shroud are formed as a modular unit.

A modular unit provides the advantage of allowing the turbine to be installed and/or removed without the need for disassembly of said modular unit. A modular configuration may enable easier transportation and installation, as well as simpler maintenance and repair. For example, the modular configuration may be installed without requiring the use of expensive machinery, such as for example a seacrane. Installation of the modular configuration therefore has much lower associated installation cost and time considerations than conventional vertical axis wind turbines. Additionally, a modular configuration may allow improved scalability, as additional modules can be added to increase power output.

The vertical axis wind turbine of embodiments may be an offshore wind turbine. When the turbine is an offshore turbine, the advantage of a modular configuration may be particularly beneficial. For example, offshore wind turbines are often located in remote and harsh environments, making maintenance and repair more challenging. Embodiments including a unit may allow for easier and more cost-effective maintenance and repair, as an individual module can be easily removed and replaced without having to dismantle or disassemble the entire turbine. A modular unit can reduce the risk associated with maintenance and repair, which can be carried out more quickly and efficiently. Further, a modular unit may enable turbines to be readily replaced or upgraded to improve performance or adapt to changing environmental conditions. As such embodiments having a modular unit may be more adaptable and future-proof, ensuring the turbine can continue to operate at optimal levels for years to come.

In another aspect of the invention a wind turbine may comprise a stack of vertical axis wind turbines in accordance with an embodiment. A stack of vertical axis wind turbines may be arranged coaxially (for example arranged around a common axle or with aligned individual axles). The stack of vertical axis wind turbines may comprise interconnected shrouds. The shrouds of adjacent vertical axis wind turbines may, for example, be connected by axially extending struts. The axially extending struts may be aligned with the stators of the adjacent shrouds. The central hubs of the stack of vertical axis wind turbines may also have interconnected central hubs.

The provision of a vertical axis wind turbine, particularly one comprising a modular unit, which is stackable is advantageous. For example, in some embodiments a stack of multiple turbines may produce the same energy as a single (larger) turbine whilst using a smaller footprint. Additionally or alternatively, a stack of multiple turbines may share a common support structure (for example a tower and/or base), which may reduce the overall material and installation costs. Further, in embodiments a stack of multiple turbines can work together to increase the efficiency and output of a facility (such as a wind farm) as a whole. For example, the stack of turbines may utilise the increased wind speed and the wake effect generated by the turbines.

The shroud, or vertical axis wind turbine comprising the shroud, may further comprise a wind energy capturing device, such as for example a kite, in communication with the turbine. The wind energy capturing device may be connected by any suitable means to the shroud, for example by a cable. The wind energy capturing device may be configured in use to be located at a higher altitude than the shroud. The wind energy capture device may be utilised to increase the total power production per unit area of the wind turbine. The shroud may be configured to capture the energy from the wind energy capturing device and converting this energy to mechanical or electrical energy.

Whilst the invention has been described above, it extends to any inventive combination of the features set out above or in the following description or drawings.

### DESCRIPTION OF THE DRAWINGS

Embodiments of the invention may be performed in various ways, and embodiments thereof will now be described by way of example only, reference being made to the accompanying drawings, in which:

FIG. 1 shows a representation of a vertical axis wind turbine in accordance with an embodiment;

FIG. 2 shows a view of the rotor of the embodiment of FIG. 1 in isolation;

FIG. 3 shows a view of the stator of the embodiment of FIG. 1 in isolation;

FIGS. 4A and 4B show modular stacked arrangements of a vertical axis wind turbine in accordance with embodiments.

### DETAILED DESCRIPTION OF EMBODIMENTS

In the field of wind turbines there is a general distinction between vertical and horizontal axis wind turbines. Accordingly, the terms horizontal and vertical are used herein for convenience. As the invention relates to a shroud for a vertical axis wind turbine it will be understood that the vertical direction as used herein corresponds to the axial direction of the wind turbine. It should also be appreciated that the horizontal and vertical directions should be interpreted broadly and do not require strict literal compliance or a narrow tolerance to the actual horizontal or vertical directions. Further it will be appreciated that in practice a shroud for a wind turbine may, whether temporarily or permanently, be in a position in which the axis is not aligned with the actual vertical. The terms upper and lower are also used herein to refer to the apparatus in its intended in use orientation. Thus, it will be understood that upper may generally mean a surface, component or direction which is vertically upward and lower may be used to generally mean a surface, component or direction

which is vertically downward. However, it will be appreciated that such references are not intended to be limiting and that the device may take any orientation in use. Likewise, any references to circumferential, radial or axial directions may be interpreted broadly as general geometric terms of orientation and, for example, do not exclude that a component may have a non-circular or irregular form.

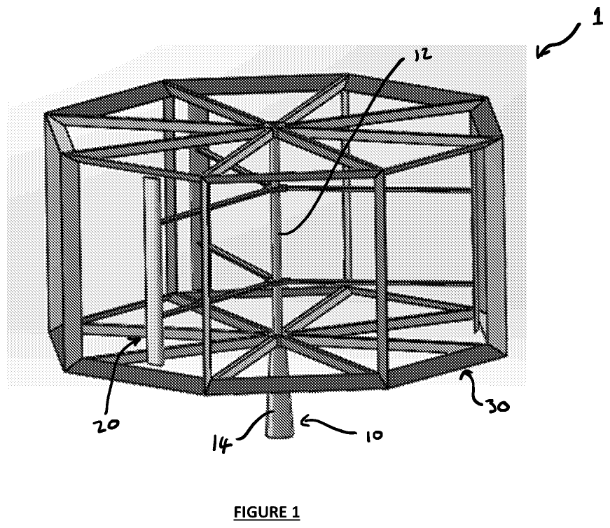

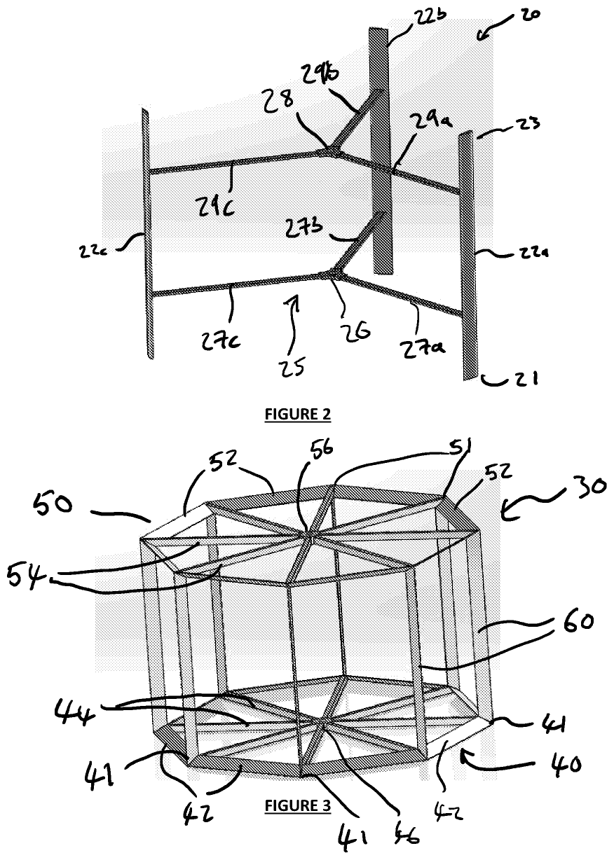

A vertical axis wind turbine 1 is shown in FIG. 1 and comprises a central hub 10, a rotor 20 and a shroud 30 which externally surrounds the rotor 20. The wind turbine 1 may, for example, be an offshore wind turbine. The specification of the wind turbine 1 will depend upon its intended use with the dimensions and properties selected, for example, based on a required power generation capacity. To aid understanding of the invention, the described embodiment is based on a 1.5 MW turbine and the detailed embodiment may be understood in this context. It will, of course, be appreciated that the turbine capacity is merely an example and as such the associated details (for example dimensions) provided in this description are non-limiting. The rotor 20 is shown in isolation in FIG. 2. The shroud 30 is shown in isolation in FIG. 3.

The central hub 10 defines the axis of the turbine, which is the nominal vertical direction, and may include a rotatable shaft 12 and a fixed support 14. The support 14 may be part of or coupled to a larger structure such as a tower or other building. The skilled person will appreciate that the wind turbine would include typical associated components (for example a substructure or support, a tower, a nacelle, a control, a drivetrain, and a generator) which will not be described in detail in the present application as they are well-known in the art and readily commercially available. The additional components will generally be associated with the central hub and will be driven by the rotation of the shaft 12 (by the rotor 20).

The rotor 20, as best seen in FIG. 2, comprises three blades 22a, 22b and 22c which are evenly circumferentially distributed around the rotor. The blades 22 extend longitudinally in the vertical direction from a lower blade tip 21 to an upper blade tip 23. Each blade is longitudinally aligned with the axis of the rotor. The blades 22 have an aerofoil cross section and it will be appreciated that the specific profile may be selected depending on the required rotor performance. For example, a standard NACA profile (such as NACA0021) may be selected.

The rotor 20 also comprises a blade support assembly 25 for the blades 22. The blade support assembly 25 couples the rotor blades to the shaft 12 of the hub 10 so that the rotor 20 is rotatable relative to the hub 10 and can cause resulting rotation of the shaft 12 for power generation. The blade support assembly 25 comprises a pair of axially spaced apart couplings 26 and 28 which both connect to the shaft 12. Three support members in the form of spokes 27a, 27b, 27c and 29a, 29b, 29c extend respectively from each coupling 26 and 28. Each of the lower spokes 27a, 27b, 27c connects to a radially inner surface of a corresponding blade 22a, 22b, 22c proximal to the lower blade tip 21. Each of the upper spokes 29a, 29b, 29c connects to a radially inner surface of a corresponding blade 22a, 22b, 22c proximal to the upper blade tip 23.

In a 1.5 MW turbine the rotor blades may have a length of approximately 30 to 40 m and a chord length of approximately 2.5 to 3.5 m. The rotor may have a diameter of approximately 55 to 65 m. Typically, the rotor may operate a rotational speed of around 12 to 14 rpm.

The shroud 30 is a truss structure in that it is formed from a plurality of structural members interconnected at nodes and is shown in isolation in FIG. 3. As seen in the assembled configuration of FIG. 1, the shroud 30 forms a cage which fully encloses the rotor 20. The shroud comprises a lower support 40 and an upper support 50 which are substantially identical. Each of the lower support 40 and upper support 50 are axially spaced apart and interconnected by a plurality of stator blades 60 (which will be further discussed below. The shape of the shroud 30 is a regular polygonal prism with the lower and upper supports 40, 50 defining the polygonal shape and the rectangular sides being defined in the axial direction. Each of the lower and upper support 40, 50 is formed of a generally planar framework aligned in a common horizontal plane. In other words, the thickness of each of the lower and upper support 40, 50 is essentially defined by the thickness of the frame material and the framework defines a two-dimensional shape in the plane of the support. The supports 40, 50 have a polygonal shape; in particular, an octagonally shape as shown in the embodiment provides an effective configuration. Each frame 40, 50 consists of an outer perimeter formed from eight straight sections 42, 52 which connect at corners 41, 51 (which coincide with the location of the stators, see below). The outer perimeter of each support provides a full circumferential loop and as it has a polygonal shape it will be appreciated that each side section is essential tangentially extending. The outer perimeter is connected and supported by radial spokes 44, 54 which each extend between the axial centre 46, 56 of the frame 40, 50 and the corners 41, 51. It will be appreciated (for example from FIG. 1) that the centre 46, 56 of the frame 40, 50 is used to connect the shroud to the central hub 10 of the turbine 1.

The straight sections 42, 52 of the outer perimeters of the upper and lower supports are formed from rectangular cross section frame work (which could include thin section plate type cross-sections). The rectangular cross section of the sections 42, 52 is angled relative to the horizontal. As such the transverse width of the sections 42, 52 can provide an inclined plane. The face of the lower frame sections 42 is upwardly angled so that it tapers upward in the radial direction and may, for example have an angle to the horizontal plane of approximately 30 degrees. The face of the upper frame sections 52 is downwardly angled so that it tapers downward in the radial direction and may, for example, have an angle to the horizontal plane of approximately 30 degrees. As a result of the angled, outwardly facing, surfaces the axially spaced apart upper and lower sections 42, 52 define a duct which axially inwardly converges in the radially inward direction.

Each of the lower support 40 and upper support 50 are axially spaced apart and interconnected by a plurality of stator blades 60. The stator blades 60 are aligned parallel to the axis of the turbine and extend longitudinally from a lower end 61 to an upper end 62. The ends 61, 62 of the stator blades are respectively connected to corresponding, circumferentially aligned, corners 41, 51 of the lower and upper supports 40, 50. As the supports 40 and 50 define an octagonal shape the shroud has eight stator blades 60a-60h. As the shroud is a regular polygonal prism the stator blades 60 are equally distributed in the circumferential direction. Each stator blade 60 is formed from a rectangular cross section beam which provides a significantly simplified structure in comparison to the use of aerofoil sections. The transverse direction of each stator blade is radially aligned. It can be appreciated that adjacent stator blades 60, along with the interposed straight sections 42, 52 of the outer perimeter of the lower support 50 and upper support 40 define a plurality of quadrilateral frames circumferentially surrounding the rotor 20. As noted above, the angle of the outwardly facing surfaces of the upper and lower sections 42, 52 ensures that each quadrilateral frame is a converging duct for incoming air blowing onto the rotor 20. Advantageously, the polygonal shape of the shroud maximises the size of each frame whilst also providing a relatively simple and robust structure.

It will be appreciated that the shroud 30 will be appropriately sized based on the rotor dimensions. A small clearance will be provided to allow for tolerances and any deviations during rotation. The shroud of embodiments may however provide a relatively compact size. For example, the internal diameter of the shroud may be approximately 1.1 times the rotor blade diameter. The stator blades may have a chord length which is approximately 1 to 1.1 times the chord length of the rotor blades.

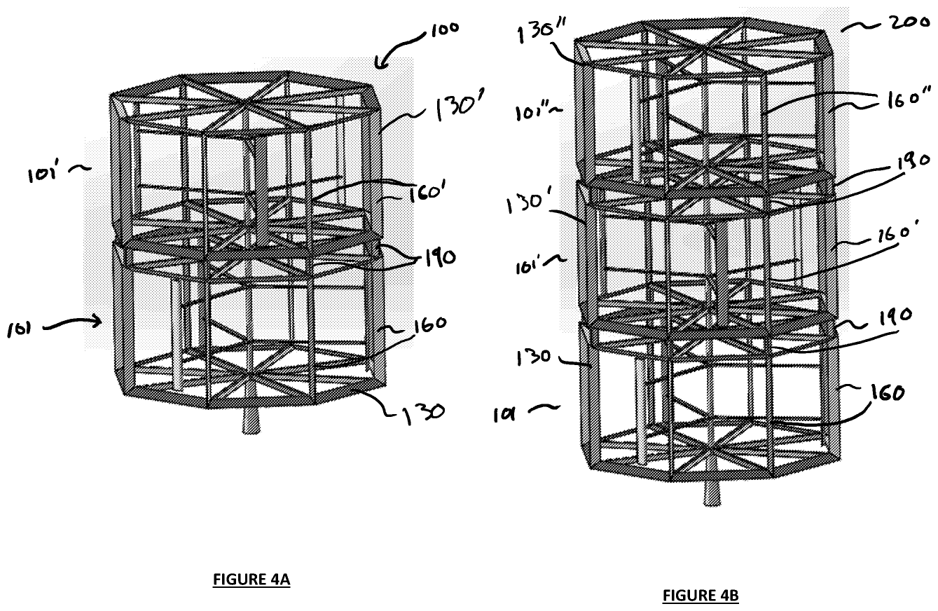

The turbine 1 of embodiments may be assembled as a modular unit comprising a pre-assembled hub 10, rotor 20 and shroud 30. This may for example enable a turbine to be erected with minimal on-site assembly and/or for turbine modules to be easily replaced for maintenance and the like. Further, in embodiments the modules may be stackable to enable a variety of configurations to be used. For example, FIGS. 4A and 4B show examples of turbines formed using a stack of 2 or 3 modular stackable vertical axis wind turbines in accordance with embodiments. If, for example, the modular turbine has a nominal output of 1.5 MW a two-unit stack 100 (FIG. 4A) could provide an output of 3 MW and a three-unit stack 200 (FIG. 4B) could provide an output of 4.5 MW. Advantageously, all these output configurations could be provided using common manufacturing, parts, and infrastructure.

In the stacked configurations the drive shafts of the hubs of each individual turbine units 101, 101′, 101″ are coaxial and interconnected (and ultimately coupled to a common output). The shrouds 130, 130′, 130″ are also coupled together to form a combined support structure. The shrouds 130, 130′, 130″ are connected by axially extending struts 160. The struts 190 are aligned with the stator blades 160, 160′, 160″ of the shrouds 130, 130′, 130″ to provide a configuration which is both structurally and aerodynamically efficient. The struts 190 provide a spacing between each modular unit 101, 101′, 101″ in a stack. It will be appreciated that the spacing can be specified and optimised depending upon the specification of the turbine 100, 200. For example, the vertical spacing (and therefore the strut 190 length) may typically be approximately 10 to 25% of the height of each modular unit (i.e., the external vertical length of the shroud).

Although the invention has been described above with reference to preferred embodiments, it will be appreciated that various changes or modification may be made without departing from the scope of the invention as defined in the appended claims.

1. A shroud for a vertical axis wind turbine, the shroud being configured in use to externally surround a rotor of a vertical axis wind turbine, wherein the shroud comprises: upper and lower axially spaced apart supports, configured in use to be respectively positioned above and below the rotor, and each support has a radially outer periphery defining a polygonal shape with a plurality of circumferentially distributed corners; a plurality of circumferentially distributed stators each extend longitudinal between a corner of the upper support and a corner of the lower support such that adjacent pairs of stators and the interposed sections of the outer periphery of the upper and lower support define a plurality of quadrilateral frames configured in use to circumferentially surround the rotor.

2. The shroud of claim 1, wherein outwardly facing surfaces of the interposed sections of the upper and lower quadrilateral frames are radially inwardly converging such that each quadrilateral frame defines a converging duct.

3. The shroud of claim 1, wherein the converging surfaces of the outwardly facing surface are angled at 30 degrees to the perpendicular to the axis of the turbine.

4. The shroud of claim 1, wherein the upper and lower supports define a regular polygonal shape, optionally polygonal shape having between 6 and 12 sides.

5. (canceled)

6. The shroud of claim 1, wherein the corresponding corners of the upper and lower supports are circumferentially aligned, and each stator extends parallel to the axis of the turbine.

7. The shroud of claim 1, wherein shroud comprises a truss structure and the upper and lower supports each comprise a generally planar framework axially separated by the plurality of stators.

8. The shroud of claim 7, wherein the upper and lower supports each comprise a plurality of radial spokes connecting the framework to the central hub.

9. The shroud of claim 8, wherein a radial spoke extends to each corner of the framework.

10. The shroud of claim 1, wherein the plurality of stators are each formed from rectangular cross section beams.

11. The shroud of claim 10, wherein the rectangular cross section beams are transversely radially aligned.

12. A vertical axis wind turbine comprising: a central hub defining the axis of the turbine, the axis being generally vertically aligned in use; a rotor comprising a plurality of blades circumferentially distributed about the axis, each blade extending longitudinally along the axial direction of the wind turbine and supported by at least one radially extending support rotatably mounting the blade relative to the central hub; and a shroud as claimed in any preceding claim.

13. The vertical axis wind turbine of claim 12, wherein a central hub, a rotor and a shroud are formed as a modular unit which can be installed and/or removed without the need for disassembly of said modular unit.

14. The vertical axis wind turbine of either of claim 12, wherein the wind turbine is an offshore wind turbine.

15. A wind turbine comprising a stack of vertical axis wind turbines as claimed in any one of claim 12.

16. The wind turbine of claim 15, wherein the stack of vertical axis wind turbines are coaxial.
